(19) United States
(12) Patent Application Publication
(10) Pub. No.: US 2018/0086611 A1
(43) Pub. Date: Mar. 29, 2018

(54) Apparatus for Lifting Heavy Loads

(71) Applicant: Mammoet Holding B.V., Utrecht (NL)

(72) Inventor: Wessel Helmens, Utrecht (NL)

(21) Appl. No.: 15/716,233

(22) Filed: Sep. 26, 2017

(30) Foreign Application Priority Data
Sep. 29, 2016 (NL) 2017553

(51) Int. Cl. B66C 23/70; B66C 23/06; B66C 19/02

(52) U.S. Cl. CPC B66C 23/70; B66C 19/02; B66C 23/06

(57) ABSTRACT

An apparatus for lifting heavy loads (and concomitant method), comprising at least one mast or part of such mast, from which a load may be suspended, wherein the apparatus is provided with an erection facility that during erection of the apparatus is invariably positionable on a supporting surface external of the apparatus and equipped to convert the apparatus between a dismantled position and a fully erected position.

### CROSS-REFERENCE TO RELATED APPLICATIONS

This application claims priority to Netherlands Patent Application No. 2017553, filed on Sep. 29, 2016, and the specification and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### BACKGROUND OF THE INVENTION

### Field of the Invention (Technical Field)

The present invention relates to a method and an apparatus for lifting heavy loads, comprising at least one mast or part of such mast, from which a load may be suspended.

### Description of Related Art Including Information Disclosed Under 37 C.F.R. §§ 1.97 and 1.98

An example of a method and apparatus is provided by U.S. Pat. No. 6,279,764, which discloses a hoisting device which is assembled from components or elements, the largest of which has dimensions which do not exceed those of a standardized sea container. Accordingly, the hoisting device can be transported easily and at low cost, and requires a short time to assemble it at the location of the hoisting job, irrespective of the required hoisting height and load weight.

WO2016/133389 discloses that there are still disadvantages with the partitioning of the hoisting device in components or elements with dimensions so that the device can be transported in standard sea containers. One problem is that its construction on-site requires a lot of space, because the masts and main boom have to be assembled on the ground to their full-length. WO2016/133389 suggest a solution for this problem by a stepwise raising of the respective masts with separate mast segments or pieces. In the method known from WO2016/133389 a back mast topslide is applied that is movable along the back mast, and which can preferably be fixed in position in a plurality of positions along the back mast. The method involves providing a back mast upper section, multiple back mast intermediate sections, and a back mast lower section, and requires the step of connecting a part of the back mast including at least the backrest upper section, and possibly one or more pre-connected intermediate sections, to the back mast topslide. The part of the back mast that has been connected to the back mast topslide is stepwise extended by attaching further back mast intermediate sections. During the extension of the back mast the back mast topslide is stepwise raised.

### BRIEF SUMMARY OF THE INVENTION

The method and apparatus of the invention is provided with the features of one or more of the appended claims.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1-11 show consecutively a series of steps for erecting an apparatus according to the invention, wherein the apparatus is embodied as a crane; and

FIGS. 12-17 show consecutively a series of steps for erecting an apparatus according to the invention, wherein the apparatus is embodied as a gantry.

### DETAILED DESCRIPTION OF THE INVENTION

In a first aspect of the invention the apparatus is provided with a ground-standing erection facility that during erection of the apparatus is invariably positionable, which erection facility comprises an assembly frame that is provided with a push-up and lowering capability for the at least one mast or part of such mast, which erection facility is equipped to receive during erection of the apparatus or to remove during dismantling of the apparatus, a mast piece or a series of mast pieces below an assembly of mast pieces above said mast piece or series of mast pieces for converting the apparatus between a dismantled position and a fully erected position.

Placement and operation of the erection facility on the ground makes handling easy. At ground level, it is more easy to supply mastpieces to the erection facility or removing mast pieces from the erection facility for converting the apparatus between a dismantled position and a fully erected position. Supplying or removing a mastpiece from the mast with the erection facility is thus entirely executable at ground level and avoids the need to use ancillary equipment on the ground or elsewhere, such as other cranes to hoist the mastpiece to its eventually intended level.

Another advantage is that the erection facility can be a general-purpose device so that the apparatus may be of any type, and need not necessarily be a crane. The versatility that this provides will be further exemplified hereinafter.

The feature that the erection facility comprises an assembly frame that is provided with a push-up and lowering capability for the at least one mast or part of such mast supports that no further ancillary equipment is required on the ground or elsewhere to assemble or to disassemble the apparatus. Accordingly, the footprint of the apparatus with the erection facility is limited to the bare minimum.

The manner of implementation of the push-up and lowering capability of the erection facility is clear to the skilled person. Reference can for instance be made to Dutch patent 1 037 817, the content of which is deemed incorporated herein by reference, and which discloses a push-up and lowering device for heavy loads. The loads as applied in this document may suitably be replaced by the masts as applied in the instant invention.

Another preferable feature of the invention to promote the ease of assembly or disassembly of the apparatus is that the at least one mast is construed as an assembly of mast pieces that are mountable to each other and dismountable from each other in a head to tail configuration.

Still another aspect of the invention is that the erection facility is movable on the supporting surface external of the apparatus. This brings about the advantage that the apparatus can be easily maneuvered over the ground and vary from one position to another without any need to first dismantle and then reassemble the apparatus again at its new position. This provides enormous time and cost savings.

As already mentioned the apparatus of the invention is of tremendous versatility which can be exemplified with reference to embodiments wherein the apparatus comprises two masts or parts thereof.

In one implementation, wherein two masts are applied the two masts can be embodied as gantry towers.

In another implementation, wherein two masts are applied the two masts can be embodied as a main boom and a back mast of a crane.

Beneficial features of this crane implemented according to the invention are:

Boom length of back mast and main boom is adjustable in operational mode (unloaded)

Length of the back mast and main boom can be changed, without bringing the boom down to ground level.

Pivot point of the back mast and the main boom are far apart and have their own crawler or load spreader set. In this way the loadbearing pressure is relatively low.

In unfavorable environmental conditions, it is not necessary to lower the main boom to ground level. The masts can be decreased in height, to a height that can withstand the extreme conditions.

Lifting of loads can be done with strand jacks or with of winches.

The invention will hereinafter be further elucidated with reference to the drawing of two exemplary embodiments of an apparatus according to the invention that is not limiting as to the appended claims.

Whenever in the figures the same reference numerals are applied, these numerals refer to the same or similar parts.

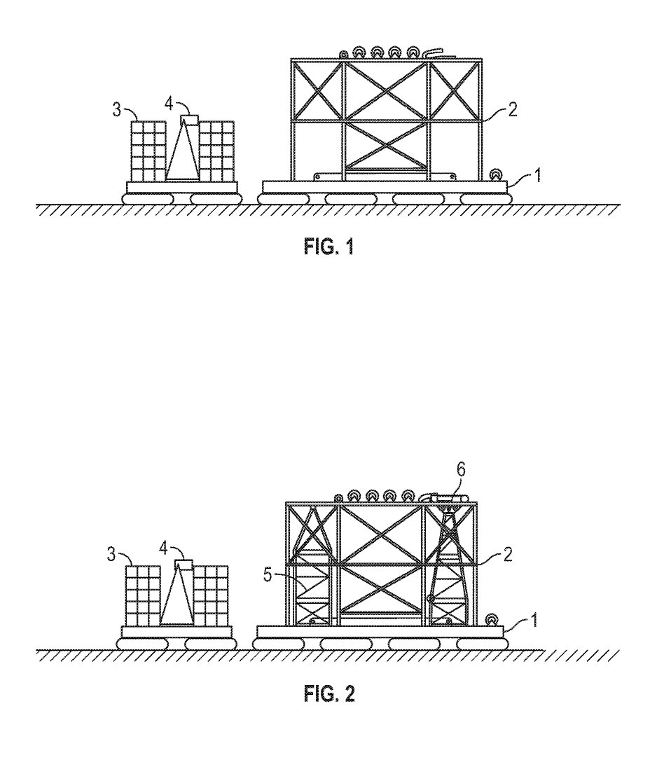

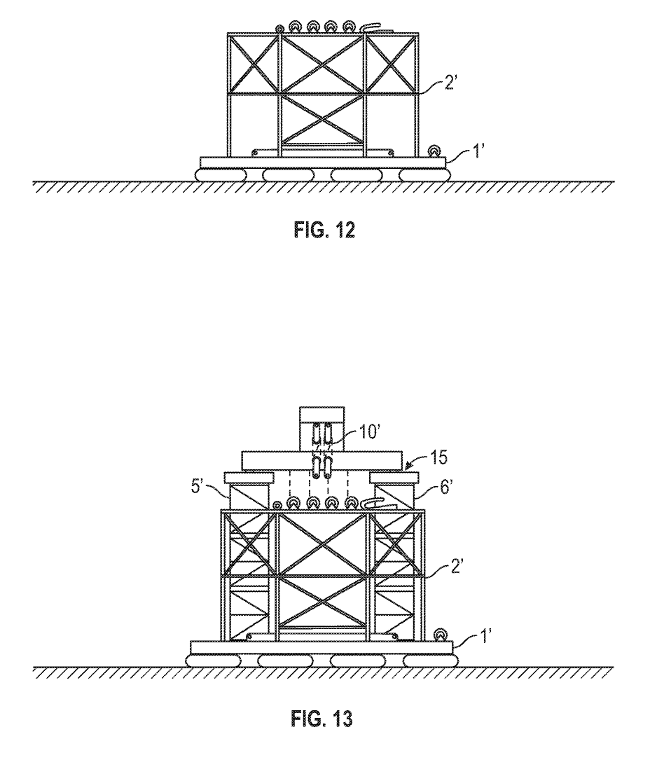

In FIG. 1 an initial position of some basic elements of an apparatus of the invention are shown that are used for assembling the apparatus from the ground up. FIG. 1 shows a base frame 1 on which an assembly frame 2 is mounted, which forms an essential element of the invention. Next to the base 1 with the assembly frame 2, is a counterweight 3 which is, like the base 1, standing on the ground. The counterweight 3 is applied since this example relates to the assembly of a crane. After completing the discussion of this example, another example will be elucidated in which the counterweight is not present, and the apparatus will be construed as a gantry. This will be shown with reference to FIGS. 12-17.

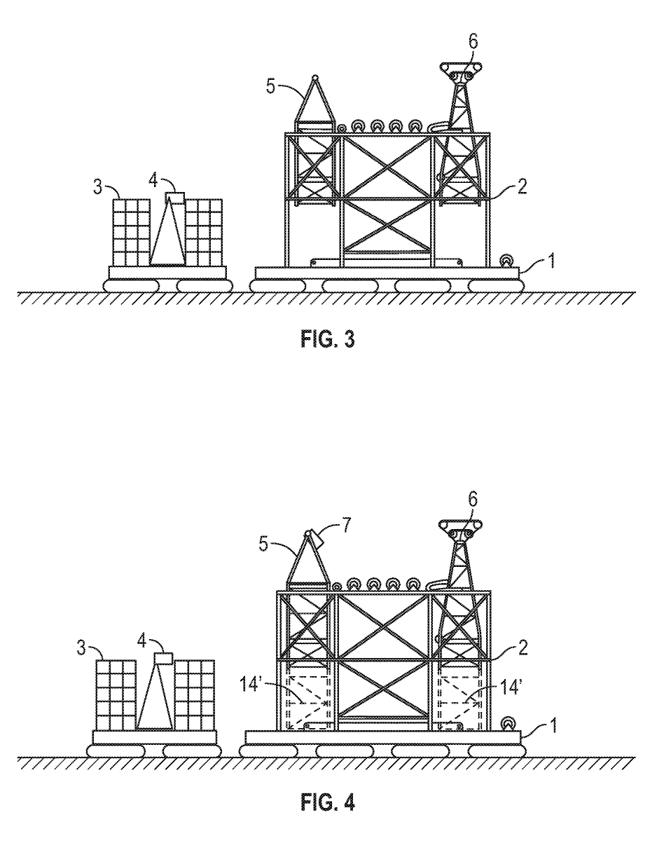

Turning now to FIG. 2 a next step in the assembly of the apparatus of the invention is shown that follows the initial situation of FIG. 1, being the placement in the assembly frame 2 of the top parts of a back mast 5 and a main boom 6 respectively. In FIG. 3 it is shown that these top parts of the back mast 5 and main boom 6 are lifted to a higher level to provide room thereunder for receiving further pieces of the back mast 5 and main boom 6 respectively that have to be assembled together with the already present parts. This is shown in FIG. 4 wherein the newly supplied pieces to the assembly frame 2 are indicated with reference 14′.

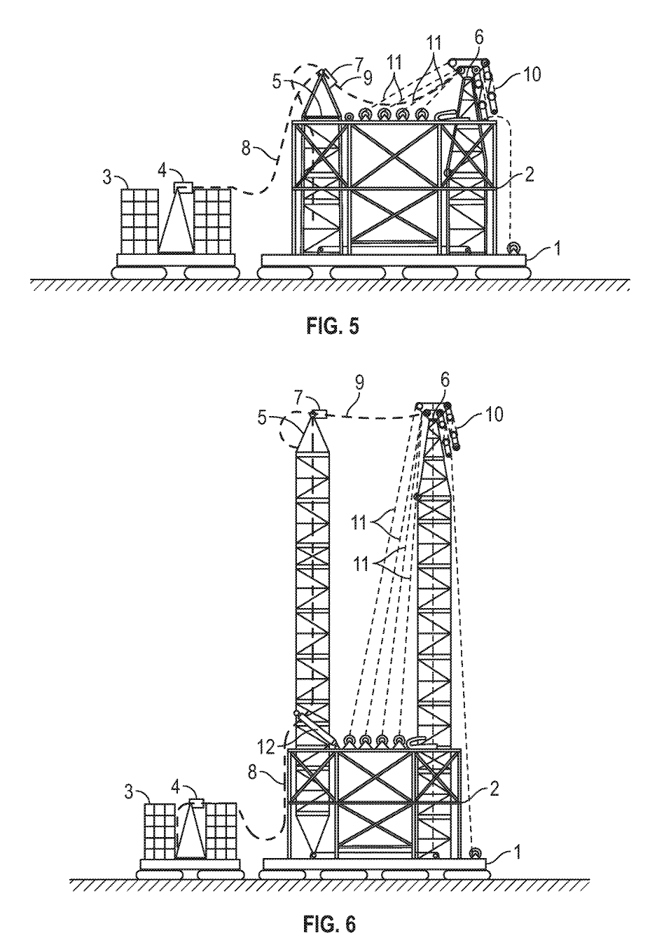

For sake of illustration FIG. 5 shows that the crane that is being assembled is also completed with several pieces of hoisting equipment, such as a counterweight hoist line 8, a main boom hoist line 9, a lifting hoist 10, and lifting hoist lines 11.

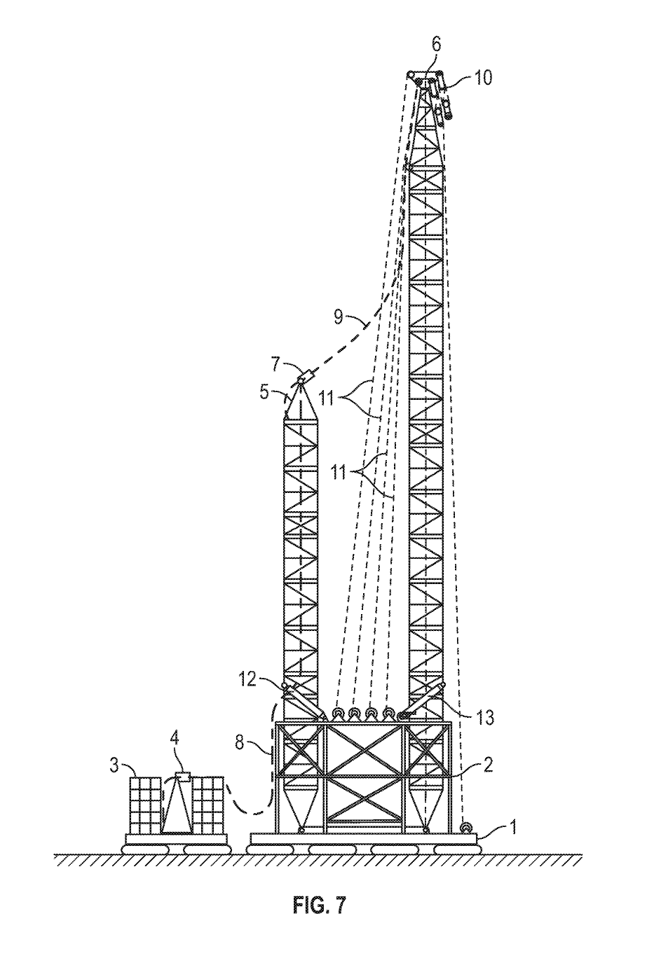

After the introduction of the newly supplied pieces 14 to the assembly frame 2′ as shown in FIG. 4, these pieces must be connected to and assembled together with the mast pieces thereabove. After that the so far assembled back mast 5 and main boom 6 can be lifted again to make room for receiving further pieces of the back mast 5 and main boom 6 respectively. This process can be continued until the back mast 5 arrives at its completion as shown in FIG. 6. Following the completion of the back mast 5 only the main boom 6 is further elevated and completed by adding the still missing mast pieces, which are connected to and assembled together with the then lower end of the main boom 6 in the assembly frame 2, in the same way as discussed above until it reaches its completion as shown in FIG. 7.

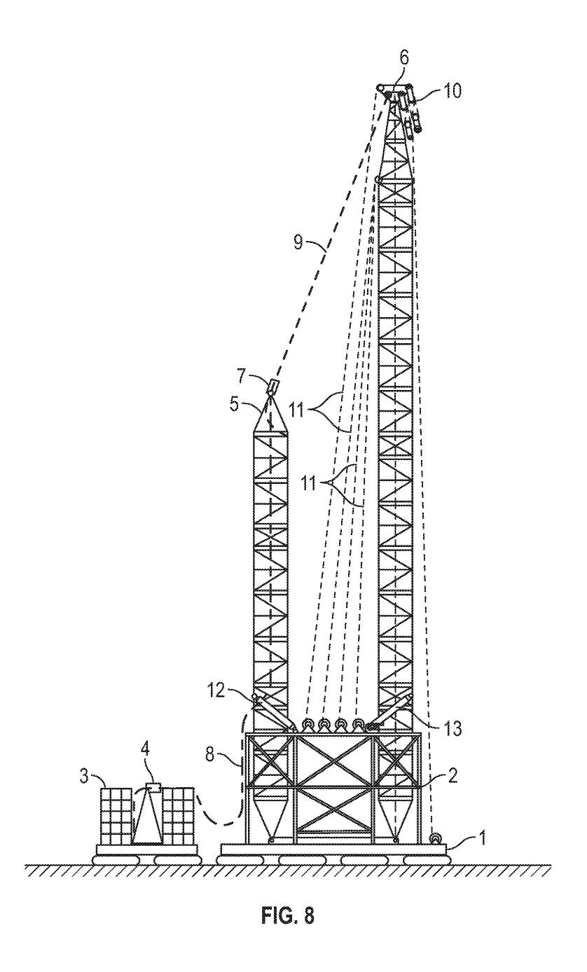

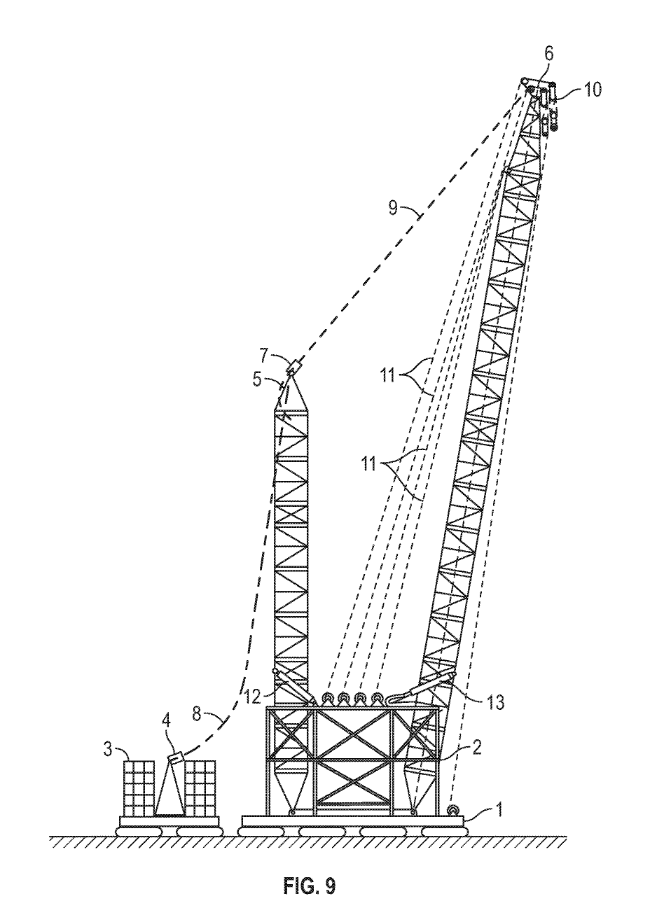

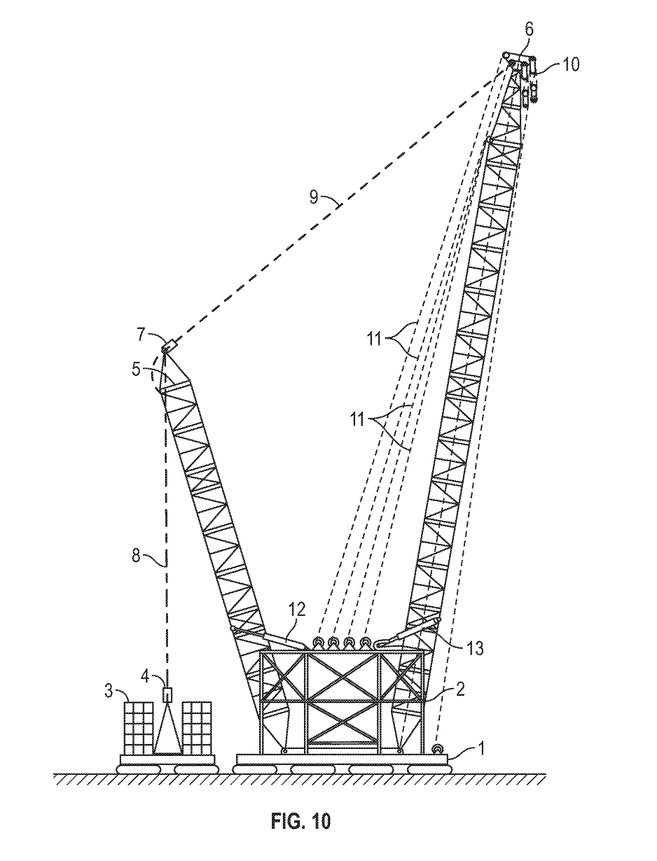

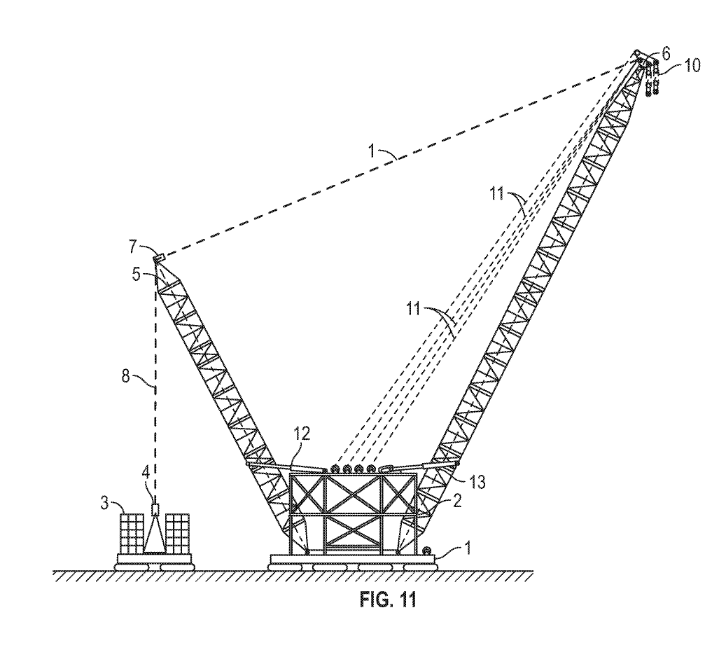

FIG. 8 represents tightening of the main boom hoist line 9 between the back mast 5 and the main boom 6, whereas FIG. 9 shows the initial phase of slanting the main boom 6. FIG. 10 represents the subsequent slanting of the back mast 5 and in FIG. 11 it is shown that the erected apparatus has reached its final working position and is ready for use.

It will be clear to the skilled person that dismantling of the apparatus can occur in the reversed order, so that it is not required to show with reference to further figures how to execute the dismantling of the apparatus.

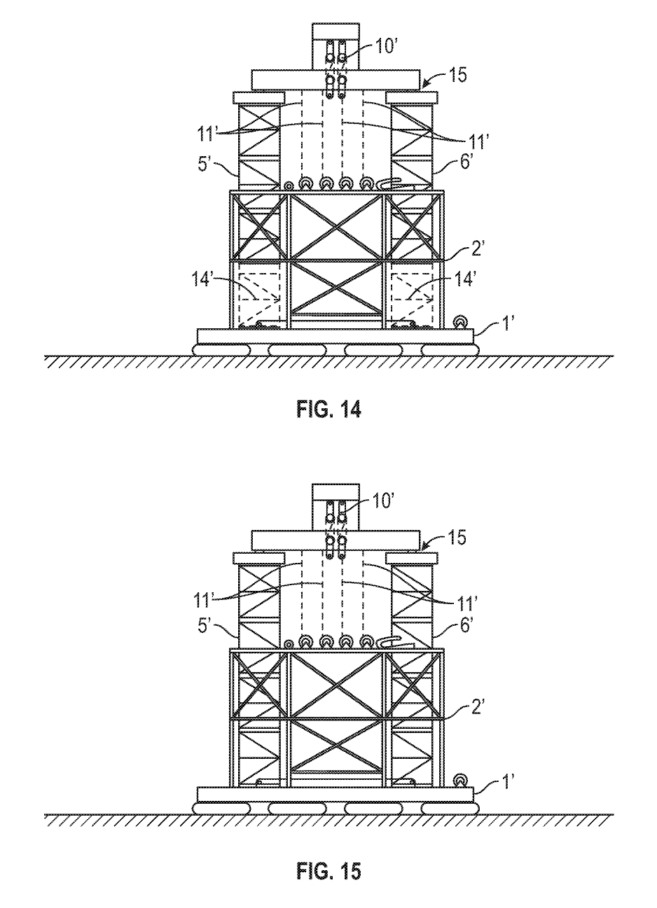

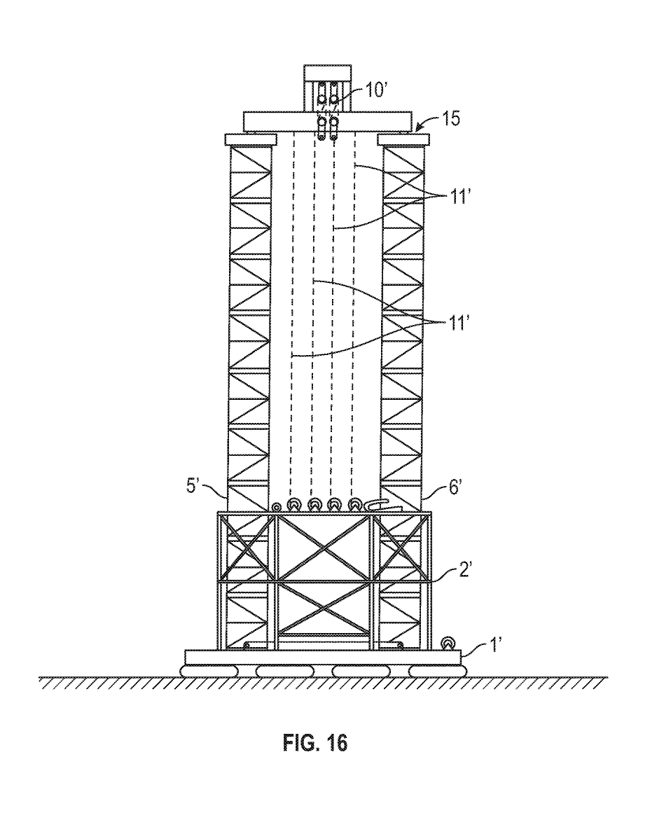

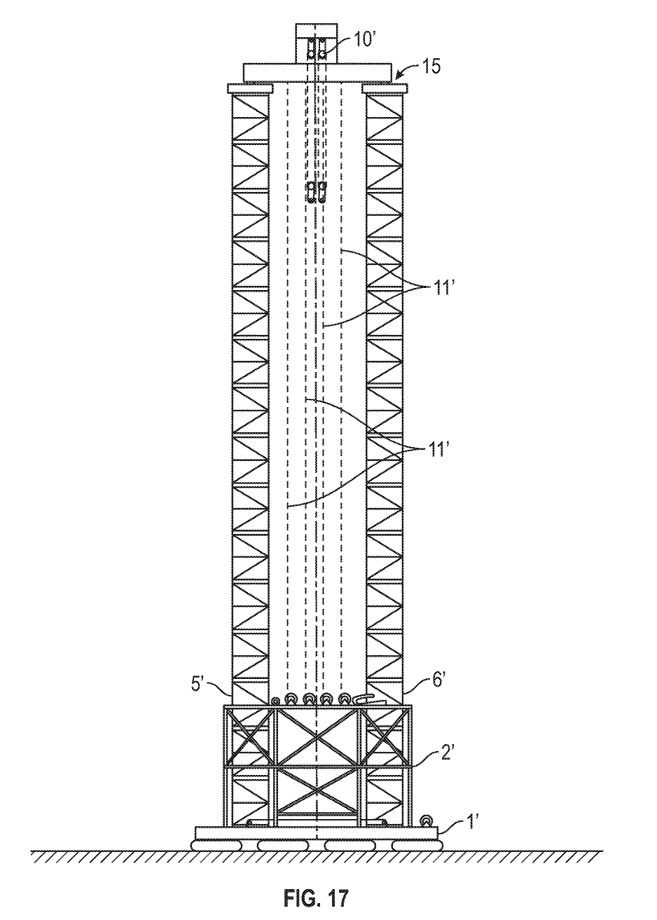

Turning now to FIG. 12 it shows again a starting position of the base frame 1 on which the assembly frame 2 is mounted, which—as mentioned above—forms an essential element of the invention. FIG. 13 shows a subsequent situation wherein the lower parts of two gantry towers or masts 5′, 6′ are placed in the assembly frame 2. In FIG. 14 the lower parts of the two gantry towers 5′, 6′ are lifted to make room thereunder in the assembly frame 2 for new mast pieces 14′. In FIG. 15 the newly added mast pieces are connected and assembled to form part of the so far assembled masts 5′, 6′, and FIG. 16 represents an intermediate step after a series of such assembly steps have been executed; wherein each step comprises the lifting of the so far assembled masts 5′, 6′ and the introduction and mounting of new mast pieces 14′ underneath the so far assembled masts 5′, 6′. In FIG. 17 finally the two gantry towers 5′, 6′ are shown at their final altitude, wherein they are ready for use.

Although the invention has been discussed in the foregoing with reference to exemplary embodiments of the apparatus of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims without intent to limit the claims to these exemplary embodiments. The scope of protection of the invention shall therefore be construed in accordance with the appended claims only, wherein a possible ambiguity in the wording of the claims shall be resolved using these exemplary embodiments.

What is claimed is:

1. An apparatus for lifting heavy loads, comprising at least one mast or part of such mast, from which a load may be suspended, wherein the apparatus is provided with a ground-standing erection facility that during erection of the apparatus is invariably positionable, which erection facility comprises an assembly frame that is provided with a push-up and lowering capability for the at least one mast or part of such mast, which erection facility is equipped to receive during erection of the apparatus or to remove during dismantling of the apparatus, a mast piece or a series of mast pieces below an assembly of mast pieces above said mast piece or series of mast pieces for converting the apparatus between a dismantled position and a fully erected position.

2. The apparatus according to claim 1, wherein the at least one mast is construed as an assembly of mast pieces that are mountable to each other and dismountable from each other in a head to tail configuration.

3. The apparatus according to claim 1, wherein the erection facility is movable on the ground external of the apparatus.

4. The apparatus according to claim 1, wherein the apparatus comprises two masts or parts thereof.

5. The apparatus according to claim 4, wherein the two masts are gantry towers.

6. The apparatus according to claim 4, wherein the two masts are a main boom and a back mast of a crane.

7. A method for assembling or disassembling an apparatus for lifting heavy loads, which apparatus comprises at least one mast, comprising:
providing an erection facility on the ground;
providing the erection facility with a push-up and lowering capability for the at least one mast or part of such mast; and
supplying to the erection facility during erection of the apparatus, or removing from the erection facility during dismantling of the apparatus, a mast piece or a series of mast pieces below an assembly of mast pieces above said mast piece or series of mast pieces so as to convert the apparatus between a dismantled position and a fully erected position.

8. The method according to claim 7, wherein the at least one mast comprises an assembly of mast pieces that are mountable to each other and dismountable from each other in a head to tail configuration.

9. The method according to claim 7, additionally comprising moving the erection facility on the ground external of the apparatus.

10. The method according to claim 7, comprising providing the apparatus with two masts or parts thereof.

11. The method according to claim 10, additionally comprising arranging the two masts as gantry towers.

12. The method according to claim 10, additionally comprising arranging the two masts as a main boom and a back mast of a crane.
